(19) United States
(12) Patent Application Publication
(10) Pub. No.: US 2026/0020050 A1
(43) Pub. Date: Jan. 15, 2026

(54) INITIAL ACCESS AND RANDOM ACCESS CHANNEL PROCEDURES FOR REDUCED CAPABILITY DEVICES

(71) Applicant: Apple Inc., Cupertino, CA (US)

(72) Inventors: Hong He, San Jose, CA (US); Chunxuan Ye, San Diego, CA (US); Dawei Zhang, Saratoga, CA (US); Haitong Sun, Saratoga, CA (US); Oghenekome Oteri, San Diego, CA (US); Seyed Ali Akbar Fakoorian, San Diego, CA (US); Wei Zeng, Saratoga, CA (US); Weidong Yang, San Diego, CA (US); Yushu Zhang, Beijing (CN)

(73) Assignee: Apple Inc., Cupertino, CA (US)

(21) Appl. No.: 19/334,706

(22) Filed: Sep. 19, 2025

Related U.S. Application Data
(62) Division of application No. 17/919,218, filed on Oct. 14, 2022.

(51) Int. Cl. H04W 74/00; H04L 5/00; H04W 74/0833

(52) U.S. Cl. CPC H04W 74/006; H04L 5/0053; H04W 74/0833

(57) ABSTRACT

The present application relates to devices and components including apparatus, systems, and methods for initial access and random access channel operations for reduced capability devices in wireless networks.

### CROSS-REFERENCES TO RELATED APPLICATIONS

This application is a divisional of U.S. patent application Ser. No. 17/919,218, filed Oct. 14, 2022, which is a 371 U.S. National Phase of PCT International Patent Application No. PCT/CN2021/128434, filed Nov. 3, 2021, which are herein incorporated by reference their entireties for all purposes.

### BACKGROUND

Reduced-capability (redcap) New Radio (NR) devices may be used in Third Generation Partnership Project (3GPP) networks. Features and parameter lists with lower-end capabilities may be needed relative to Release 16 and future releases enhanced mobile broadband (eMBB) and ultra-reliable and low-latency communication (URLCC) in NR. These redcap devices may be used for industrial wireless sensors, video surveillance, or wearable devices. With respect to non-recap UEs, redcap UEs may have less receive/transmit antennas, reduced bandwidth, half-duplex frequency division duplexing (instead of full-duplex), relaxed UE processing time, and relaxed UE processing capability.

### BRIEF DESCRIPTION OF THE DRAWINGS

FIG. 1 illustrates a network environment in accordance with some embodiments.

FIG. 2 illustrates a resource configuration in accordance with some embodiments.

FIG. 3 illustrates a resource grid in accordance with some embodiments.

FIG. 4 illustrates another resource grid in accordance with some embodiments.

FIG. 5 illustrates another resource grid in accordance with some embodiments.

FIG. 6 illustrates another resource configuration in accordance with some embodiments.

FIG. 7 illustrates an operation flow/algorithmic structure in accordance with some embodiments.

FIG. 8 illustrates another operation flow/algorithmic structure in accordance with some embodiments.

FIG. 9 illustrates another operation flow/algorithmic structure in accordance with some embodiments.

FIG. 10 illustrates a user equipment in accordance with some embodiments.

FIG. 11 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B).

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

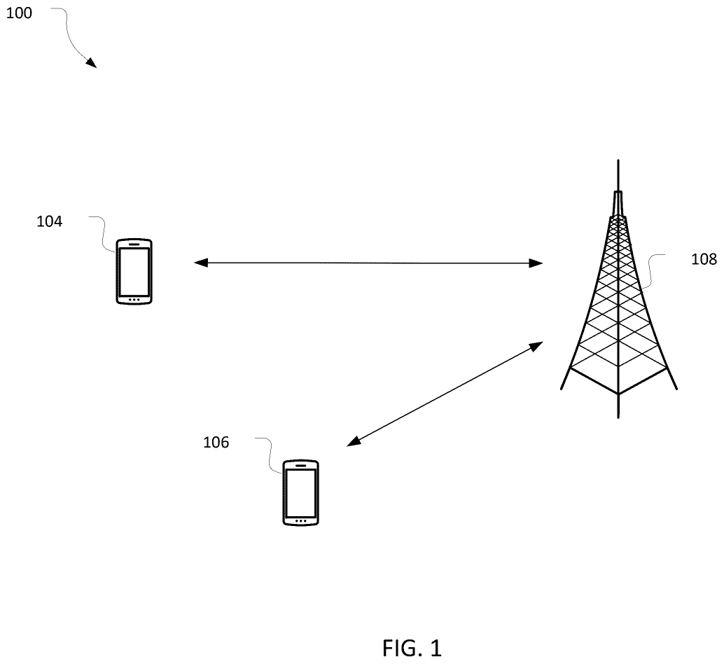

FIG. 1 illustrates a network environment 100 in accordance with some embodiments. The network environment 100 may include UE 104, UE 106, and a base station 108. The base station 108 may provide one or more wireless access cells, for example, NR cells, through which the UEs 104/106 may communicate with the base station 108. The UEs 104/106 and the base station 108 may communicate over air interfaces compatible with Fifth Generation (5G) NR system standards as provided by 3GPP technical specifications. The base station 108 may be a next generation node B (gNB) that provides one or more 5G NR cells to provide NR user plane and control plane protocol terminations toward the UEs 104/106.

The UEs 104/106 may utilize random-access channel (RACH) procedures to access resources provided by the base station 108. In some embodiments, the UEs 104/106 may use a four-step RACH procedure or a two-step RACH procedure.

A four-step RACH procedure may be as follows. In a first step, the UE 104/106 may randomly select a preamble from a pool of shared preambles and transmit the preamble to the base station 108 in a first message (Msg1). In a second step, the base station 108 may respond to the first message by transmitting a random-access response (RAR) in a second message (Msg 2). The RAR may include a random access preamble identifier, timing alignment information, initial uplink grant, and temporary C-RNTI (TC-RNTI). If the UE 104/106 receives a PDCCH with the RAR within a defined time window, and the RAR includes a preamble identifier that corresponds to the preamble transmitted in Msg1, the response is successful. Then, in the third step, the UE 104/106 may send a scheduled uplink transmission over a PUSCH in a third message (Msg3). The third message may include an ID for contention resolution. In the fourth step, the base station 108 may send the contention resolution ID in a fourth message (Msg4) that, if properly decoded by the UE 104/106, may complete the procedure.

A two-step RACH procedure may be as follows. In a first step, the UE 104/106 may transmit a first message (MsgA) that includes a PRACH preamble transmission and a PUSCH transmission. Thus, MsgA represents a combination of Msg1 and Msg3 of the four-step procedure. In a second step, the base station 108 may respond with a second message (MsgB) that includes both random access response and contention resolution content. Thus, MsgB represents a combination of Msg2 and Msg4 of the four-step procedure.

In some embodiments, the UE 104 may be a redcap UE and the UE 106 may be a non-redcap UE 106. The redcap UE 104 may be desired to reduce device complexity and energy consumption as compared to the non-redcap UE 106. For example, the redcap UE 104 may have less transmit/receive capabilities as compared to the non-redcap UE 106. Some UE reduction features include reduced number of receive/transmit antennas (for example, less than four), UE bandwidth reduction (for example, up to 20 MHz), half-duplex frequency division duplexing, relaxed UE processing time, and relaxed UE processing capability.

The maximum bandwidth supported for the redcap UE 104 may depend on the frequency range in which it operates. For example, if the redcap UE 104 operates in frequency range 1 (FR1), from 410 MHz to 7125 MHz, a maximum bandwidth of 20 MHz may be supported during and after initial access. In other embodiments, other maximum bandwidths (for example, 40 MHz) may be supported. If the redcap UE 104 operates in frequency range 2 (FR2), from 24.2 5 GHz to 52.6 GHz, a maximum bandwidth of 100 MHz may be supported during and after initial access.

In previous 3GPP Releases, an initial downlink (DL)/uplink (UL) bandwidth part (BWP) may be configured up to an entire component carrier bandwidth. This may be larger than the 20 MHz supported by the redcap UE 104 in FR1. Scheduling complexity and resource utilization may benefit from having a same initial DL/UL BWPs for both redcap and non-redcap UEs. However, this may complicate random-access procedures and present issues with respect to frequency hopping.

Embodiments of the disclosure correspond to least three aspects. In a first aspect, embodiments describe how to configure redcap-specific initial DL/UL BWP, how to transmit the system information in system information block (SIBs), and how to provide notifications that the SIB information has been updated in a manner to reduce power consumption. In a second aspect, embodiments describe how to control physical uplink control channel (PUCCH) frequency hopping to address physical uplink shared channel (PUSCH) resource fragmentation concerns, and how to provide PUCCH orthogonality between redcap-PUCCH without frequency hopping and non-redcap PUCCH with frequency hopping. In a third aspect, embodiments describe how to provide an early indication of a redcap device type using a Msg1-based approach or a Msg3-based approach. The embodiments described herein improve resource efficiency for both redcap and non-redcap UEs.

With respect to the first aspect, a variety of signaling approaches may be considered to provide separate system information for redcap UEs that may facilitate the initial access procedure. In some designs, redcap-dedicated system information may include configuration information to configure a redcap-dedicated initial DL BWP or configuration information to configure a redcap-dedicated initial UL configuration.

Table 1 illustrates a parameter structure of configuration information used to configure a redcap-dedicated initial DL BWP in some embodiments.

TABLE 1
Redcap-dedicated initial DL BWP

| | | |
|---|---|---|
| Generic parameters | LocationAndBandwidth | 0 to 37,949 |
| | SCS | 15, 30, 60, 120, |
| | | 480, 960 |
| | CyclicPrefix | Extended |

| | |
|---|---|
| pdcch-ConfigCommon- | Type1-CSS (Mandatory) |
| Redcap | Type0/Type2/Type3-CSS (Optional) |
| ssbFrequency-Redcap | ARFCN-valueRedcap (Mandatory or Optional) |

The parameter structure may include generic parameters, cell specific parameters for a PDCCH of the redcap-dedicated initial DL BWP (pdcch-ConfigCommon-Redcap), and a parameter to indicate a location of a non-cell-defined (CD)-synchronization signal block (SSB) (ssbFrequency-Redcap).

The generic parameters may include a location and bandwidth (LocationAndBandwidth) information element (IE) to indicate a frequency domain location and bandwidth of the redcap-dedicated initial DL BWP. The location and bandwidth IE may specify a set of contiguous common resource blocks that belong to the redcap-dedicated initial DL BWP. The value of the LocationAndBandwidth field may be interpreted as a resource indicator value as defined in 3GPP TS 38.214 v16.7.0 (2021-09-28).

The generic parameters may also include a subcarrier spacing (SCS) IE to indicate a value, in kilohertz (KHz), of the subcarrier spacing of the redcap-dedicated initial DL BWP.

The generic parameters may further include a cyclic prefix (CyclicPrefix) IE that may be set to indicate an extended cyclic prefix is to be used.

The cell-specific parameters for the redcap PDCCH may configure one or more common search space (CSS) sets for the redcap-dedicated initial DL BWP. In some designs, a Type1-CSS set may be mandated to be configured by a random-access search space (ra-searchspace) IE within the pdcch-ConfigCommon-Redcap IE. Redcap UEs may be deployed in high numbers, which may cause initial access congestion issues. Thus, a Type1-CSS set may be configured to offload the random access procedures of the redcap UEs. The Type1-CSS set may be up to 96 resource blocks in some embodiments.

In some designs, various optional CSSs may be configured within the redcap-dedicated initial DL BWP. For example, a type0-CSS may be configured for SIB information, a type2-CSS may be configured for paging transmissions, and type3-CSS may be configured for scheduling or power and slot format control. In general, the optional CSSs may be configured based on discretion of a scheduler of the base station 108 to accommodate various deployment scenarios. For example, the scheduler may determine whether it is desirable to configure optional CSSs in the redcap-dedicated initial DL BWP to avoid the redcap UEs having to re-tune radio-frequency (RF) circuitry to obtain necessary information elsewhere in the larger bandwidth of the initial DL BWP.

In some embodiments, an ssbFrequency-Redcap IE may indicate a location of a non-CD-SSB that is to be transmitted in the redcap-dedicated initial DL BWP. The non-CD-SSB may be transmitted to allow a redcap UE to perform radio resource management (RRM) measurements and adjust time/frequency drift of a local oscillator without having to retune RF circuitry to obtain the CD-SSB transmitted outside of the redcap-dedicated initial DL BWP.

The location may be provided by an absolute radio-frequency channel number (ARFCN-valueRedCap), which may be mandatory or optional. In the event a non-CD-SSB is transmitted, it should not be transmitted on a synchronization raster, for example, a global synchronization channel number (GSCN), in order to avoid impact on cell search for non-redcap UEs.

Presence of the non-CD-SSB configuration in the redcap-dedicated initial DL BWP may depend on the CSSs configured for the redcap-dedicated initial DL BWP. If non-CD-SSB in the redcap-dedicated initial DL BWP is present, the UE will expect that non-CD-SSB is always transmitted based on the non-CD-SSB configuration. For example, a non-CD-SSB may be present based on one of the following three options.

In a first option, the non-CD-SSB may be present if Type2-CSS is configured for the redcap-dedicated initial DL BWP, but may not be present if only Type1-CSS is configured.

In a second option, when Type2-CSS is configured in the redcap-dedicated initial DL BWP, the presence of the non-CD-SSB may depend on the configuration of a discontinuous reception (DRX) cycle or SSB-based measurement timing configuration (SMTC) periodicity. For example, the non-CD-SSB may only be present when a DRX cycle or SMTC period is smaller than a predetermined threshold.

In a third option, the non-CD-SSB may always be present, regardless of the CSS types configured in the initial DL BWP.

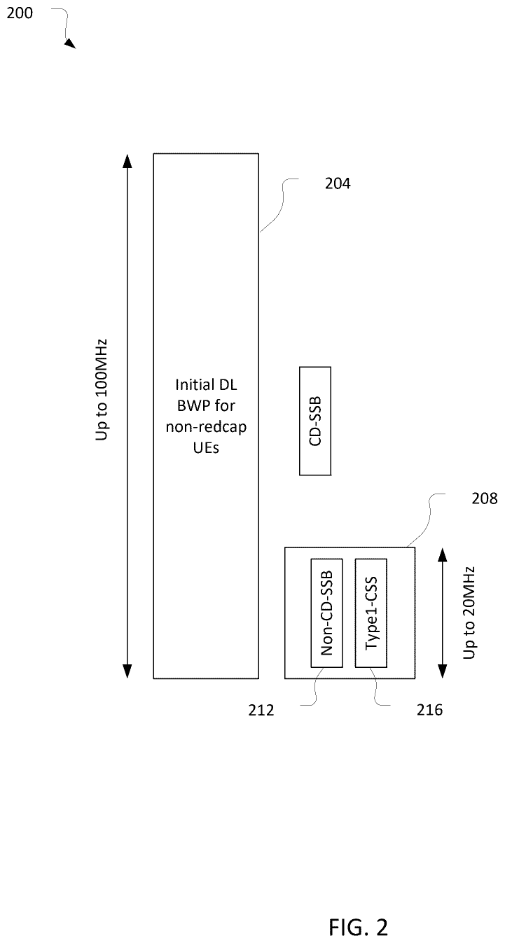

FIG. 2 illustrates a resource configuration 200 in accordance with some embodiments. The resource configuration 200 may include a non-redcap initial DL BWP 204 that may be configured by SIB1 for non-redcap UEs, for example, UE 106. The non-redcap initial DL BWP 204 may have a bandwidth of up to 100 MHz in some embodiments.

The resource configuration 200 may further include a redcap-dedicated initial DL BWP 208 that is configured for redcap UEs, for example, UE 104. The redcap-dedicated initial DL BWP 208 may have a bandwidth of up to 20 MHz in some embodiments. The redcap-dedicated initial DL BWP 208 may include a non-CD SSB 212 and a Type1-CSS 216.

The resource configuration 200 may include a CD-SSB 220 for non-redcap users. Redcap users may also use the CD-SSB 220 to facilitate initial acquisition of the redcap-dedicated system information. After this initial acquisition, redcap users may be able to identify and camp on the redcap-dedicated initial DL BWP 208. Thereafter, the redcap users may use the non-CD-SSB 212 and Type1-CSS 216 to perform any random access procedures. In the event the redcap-dedicated initial DL BWP 208 is configured with other CSSs (not shown in FIG. 2), the redcap users may also perform other operations consistent with the configured CSSs.

Table 2 illustrates a parameter structure of configuration information used to configure a redcap-dedicated initial UL BWP in some embodiments. The redcap-dedicated initial UL BWP may be used for uplink transmission during a RACH procedure.

TABLE 2
Redcap-dedicated initial UL BWP

| | | |
|---|---|---|
| Generic | LocationAndBandwidth | 0 to 37,949 |
| parameters | SCS | 15, 30, 60, 120, |
| | | 480, 960 |
| | CyclicPrefix | Extended |

| | |
|---|---|
| RACH- | Redcap-specific setting including SSB association, |
| ConfigCommon- | FDMed ROs, power-ramping step, time-domain |
| Redcap | periodicity and density, etc. |
| PUCCH- | RB offset to avoid collision with PUCCH resource |
| ConfigCommon- | reserved for non-redcap UEs |
| Redcap | Frequency hopping enable/disable |

The parameter structure may include generic parameters, parameters for RACH resource configuration (RA CH-ConfigCommon-Redcap), and parameters for a PUCCH resource configuration (PUCCH-ConfigCommon-Redcap).

The generic parameters may include a location and bandwidth (LocationAndBandwidth) IE to indicate a frequency domain location and bandwidth of the redcap-dedicated initial UL BWP. The location and bandwidth IE may specify a set of contiguous common resource blocks that belong to the redcap-dedicated initial UL BWP. The value of the LocationAndBandwidth field may be interpreted as a resource indicator value as defined in 3GPP TS 38.214 v16.7.0 (2021-09-28).

The generic parameters may also include an SCS IE to indicate a value, in kHz, of the subcarrier spacing of the redcap-dedicated initial UL BWP.

The generic parameters may further include a CyclicPrefix IE that may be set to indicate an extended cyclic prefix is to be used.

The parameters for the RACH resource configuration (RACH-ConfigCommon-Redcap) may provide an early indication of a redcap UE to the base station 108. Identifying a UE as a RedCap UE early in a RACH procedure may allow the base station 108 to configure the UE-specific Msg3/Msg4 transmissions in a desired manner. This may include configuring the UE-specific Msg3/Msg4 transmissions with a larger repetition and proper resources in the frequency domain. The RACH parameters for the redcap UEs may be different than the SIB1-configured RACH resources for non-redcap UEs. The different RACH parameters may include, but are not limited to, a number of SSBs associated with a valid RACH occasion (RO), a number of frequency division multiplexed (FDMed) ROs, a power-ramping step, and time-domain periodicity and density.

The parameters for the PUCCH resource configuration (PUCCH-ConfigCommon-Redcap) may provide a resource block offset to avoid collision with PUCCH resources reserved for non-redcap UEs; and an indication of whether frequency hopping is enabled or disabled for PUCCH transmissions in the redcap-dedicated initial UL BWP.

In some embodiments, the redcap-specific initial DL/UL BWP configuration parameters may be provided using dedicated IEs in an existing SIB1. The SIB1, which may provide parameters that the UEs may use for initial access to a cell, may be transmitted using a broadcast control channel (BCCH) logical channel, a downlink shared channel (DL-SCH) transport channel, and a PDSCH physical channel.

In other embodiments, separate SIB(s) may be introduced and used for RedCap UEs. A SIB specifically designed for signaling redcap-specific initial DL/UL BWP configuration parameters may be referred to as a SIB-redcap.

In some embodiments, the base station 108 may use a short message notification mechanism to provide UEs with an indication that a SIB has been updated. However, using existing mechanisms may cause unnecessary power consumption for SIB message acquisition in some instances. For example, the existing mechanisms may cause both redcap and non-redcap UEs to acquire system information even if only one of redcap-dedicated SIB or legacy SIB information is updated. Therefore, embodiments describe various options to provide an indication that redcap-dedicated system information has been updated.

In a first option, the base station 108 may indicate that a SIB-redcap has been modified using a short message notification process. This indication, which may be referred to as a redcap-SI modification (SystemInfoModificationRedcap) indication, may be transmitted on the PDCCH using a paging-radio network temporary identity (P-RNTI) with or without an associated paging message. For example, the redcap SI modification indication may be one-bit in a short-message field in DCI format 1_0. Table 3 provides bit values of a short message field that includes the redcap SI modification indication. This table may replace the short message table that lacks the redcap SI modification indication in TS 38.331, clause 6.5.

TABLE 3

| Bit | Short message |
|---|---|
| 1 | systemInfoModification |
| | If set to 1: indication of a BCCH modification other than SIB6, SIB7, |
| | SIB8, and redcap-specific configuration in SIB 1 (or SIB-redcap). |
| 2 | etwsAndCmasIndication |
| | If set to 1: indication of an ETWS primary notification and/or an |
| | ETWS secondary notification and/or a CMAS notification. |
| 3 | stopPagingMonitoring |
| | This bit can be used for only operation with shared spectrum channel |
| | access and if nrofPDCCH-MonitoringOccasionPerSSB-inPO is |
| | present. If set to 1: indication that the UE may stop monitoring |
| | PDCCH occasion(s) for paging in this Paging Occasion as specified |
| | in TS 38.304 v16.6.0 (2021 Sep. 27), clause 7.1. |
| 4 | SystemInfoModificationRedcap |
| | If set to 1: Indication of a BCCH modification for Redcap-specific |
| | configurations |
| 5-8 | Reserved |

In another option, the base station 108 may indicate the SIB-redcap modification using another field of a DCI format 1_0 transmission with cyclic redundancy check (CRC) bits scrambled by P-RNTI. In existing designs, there are six reserved bits in these transmissions. One or more of these reserved bits may be used to indicate the SIB-redcap modification.

In another option, a separate P-RNTI may be used to indicate the SIB-redcap modification. The separate P-RNTI may be referred to as P-RNTI-Redcap. The base station 108 may indicate the SIB-redcap modification by transmitting a DCI format 1_0 transmission with CRC bits scrambled by the P-RNTI-Redcap. The P-RNTI-redcap may be predefined in a 3GPP TS or be explicitly configured in SIB 1/SIB-Redcap and shared for all redcap UEs.

In another option, the base station 108 may indicate the SIB-redcap modification by selecting a specific scrambling sequence [w₀, w₁, . . . , w₂₃] to scramble the CRC bits of DCI format 1_0 transmission with P-RNTI. For example, two scrambling sequences may be defined according to Table 4.

TABLE 4

| b(0) | [w₀, w₁, w₂, . . . , w₂₃] |
|---|---|
| 0 | [0, 0, 0, . . . , 0] |
| 1 | [1, 1, 1, . . . , 1] |

The value of b(0)=0 may indicate that there is no SIB-redcap modification and the value of b(0)=1 may indicate that there is a SIB-redcap modification. Thus, the base station 108 may first scramble the CRC bits of DCI format 1_0 with P-RNTI and, to indicate a SIB-redcap modification, may perform additional scrambling using sequence [1, 1, 1, . . . , 1] on top of the P-RNTI.

In another option, the base station 108 may indicate the SIB-redcap modification by using a specifically configured search space. For example, a different Type2-CSS may be configured for redcap UEs. If a redcap UE detects a DCI 1_0 transmission with P-RNTI in the Type2-CSS configured for redcap UEs, it will determine that a SIB-redcap modification has occurred.

With respect to the second aspect, some embodiments describe dynamically enabling or disabling PUCCH frequency hopping. A variety of options may be used to enable/disable PUCCH frequency hopping during an initial access procedure.

In a first option, the PUCCH frequency hopping may be enabled/disabled by SIB1/SIB-redcap as part of the redcap-dedicated initial UL BWP configuration as described above with respect to Table 2. In some instances, this cell-level enabling/disabling of frequency hopping may be associated with the degradation of PUCCH performance due to lack of frequency diversity gain. This could result in a RACH procedure failure for some cell-edge redcap UEs. A second option, described below, may at least partially mitigate this issue.

In the second option, the PUCCH frequency hopping may be enabled/disabled by DCI format 1_0 that schedules the contention resolution PDSCH (for example, Msg4) of the 4-step RACH procedure or the random access response/contention resolution PDSCH (MsgB) of the 2-step RACH procedure.

In some embodiments, the enabling/disabling of frequency hopping may be indicated by repurposing one or two bits of the two-bit downlink assignment index (DAI) field in the scheduling DCI format 1_0. One bit of the two-bit DAI field may be used to indicate that PUCCH hopping is enabled or disabled. Alternatively, both bits of the two-bit DAI field may be used to jointly indicate intra-slot and inter-slot frequency hopping. For example, the two-bit DAI field may be interpreted for PUCCH frequency hopping purposes based on Table 5 below.

TABLE 5

| Value of repurposed | |
|---|---|
| 2-bit DAI field | PUCCH frequency hopping |
| ‘00’ | Disabled |
| ‘01’ | Enabled, Intra-slot hopping |
| ‘10’ | Enabled, Inter-slot hopping |
| ‘11’ | Enabled, ‘intra-slot + inter-slot hopping’ or |
| | ‘reserved’ |

In another option, the PUCCH frequency hopping may be dynamically enabled/disabled using a selected scrambling sequence to scramble the CRC of the scheduling DCI format 1_0 similar to that described above with respect to Table 4. For example, the base station 108 may set the hopping bit to one (for example, b(0)=1) to enable PUCCH frequency hopping by using an all ‘1’ scrambling sequence. In other embodiments, other bit values may be used to convey various PUCCH frequency hopping settings.

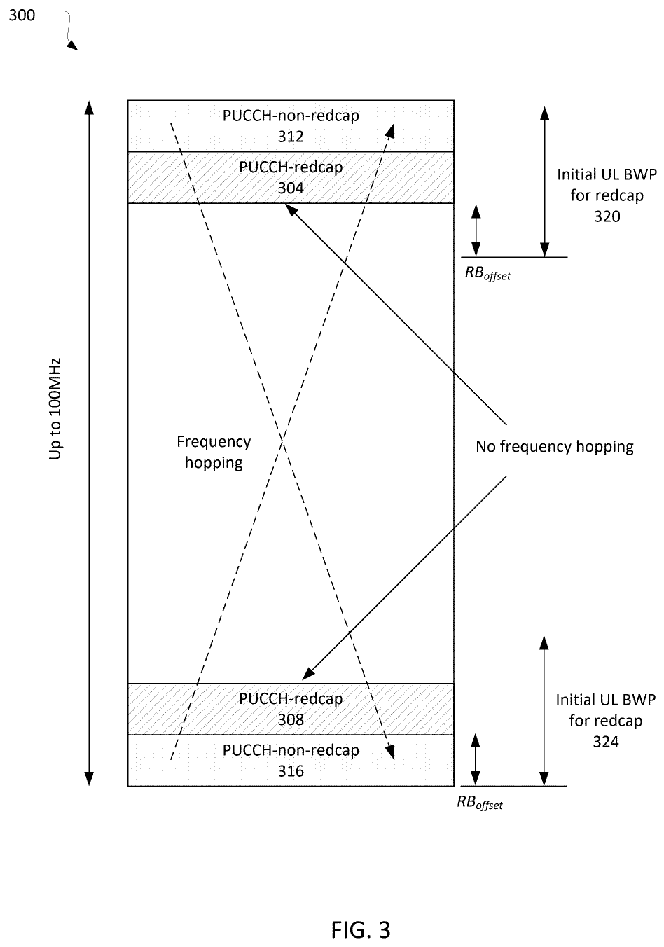

FIG. 3 illustrates a resource grid 300 having PUCCH regions for redcap and non-recap users in accordance with some embodiments. The resource grid 300 may be used to illustrate different approaches for configuration of PUCCH resource sets for redcap UEs (denoted as PUCCH-redcap 304 and PUCCH-redcap 308, which may be configured for different redcap UEs) and PUCCH resource sets for non-redcap UEs (denoted as PUCCH-non-redcap 312 and PUCCH-non-redcap 316). These PUCCH resource sets may be used before a UE is provided with a dedicated PUCCH resource set. For example, they may be used when the UE is in an RRC idle state.

In this embodiment, the resource blocks of the PUCCH-non-redcap regions do not overlap in frequency with resource blocks of the PUCCH-redcap regions. The first PRB of a PUCCH-redcap region may be implicitly determined as the resource block adjacent to a highest or lowest PRB of the at least one PRB of the PUCCH-non-redcap region that is included in the redcap-dedicated initial UL BWP.

For example, the resource grid 300 may include a first initial UL BWP for redcap 320 that includes the PUCCH-redcap 304 and the PUCCH-non-redcap 312. A redcap UE (for example, redcap UE 104) may read a SIB1 to determine the location of the PUCCH-non-redcap 312 and may then be able to identify the PUCCH-redcap 304 as the region immediately adjacent a lowest PRB of the PUCCH-non-redcap 312.

The resource grid 300 may also include a second initial UL BWP for redcap 324 that includes the PUCCH-redcap 308 and the PUCCH-non-redcap 316. A redcap UE (for example, redcap UE 104) may read a SIB1 to determine the location of the PUCCH-non-redcap 316 and may then be able to identify the PUCCH-redcap 308 as the region immediately adjacent a highest PRB of the PUCCH-non-redcap 316.

Given that a particular redcap user will operate in either the initial UL BWP for redcap 320 or the initial UL BWP for redcap 324, frequency hopping between these regions may not be enabled. Frequency hopping between PUCCH-non-redcap 312 and PUCCH-non-redcap 316 may be possible for non-redcap users as both regions are within the larger initial UL BWP for non-redcap users.

In another option, a resource block offset (RB_{offset}) may be configured as part of the redcap-dedicated initial UL BWP configuration as discussed above with respect to Table 2. The resource block offset may represent an offset between a lowest PRB index of the PUCCH-redcap region and a lowest PRB index of the initial UL BWP for redcap. The redcap UE 104 may determine the lowest PRB index of the PUCCH-redcap region (PRBₛₜₐᵣₜ) based on Equation 1 as follows:

$${PRB}_{start} = {RB}_{offset} + ⌊ {r}_{PUCCH} / {N}_{CS} ⌋ , \qquad Equation 1$$

where N_{CS} is the total number of initial CS indexes configured by higher layers, r_{PUCCH} represents the PUCCH resource index that is determined based on the first control channel element (CCE) of a scheduling DCI and a PDSCH resource element mapping indicator (PRI) field value in the scheduling DCI.

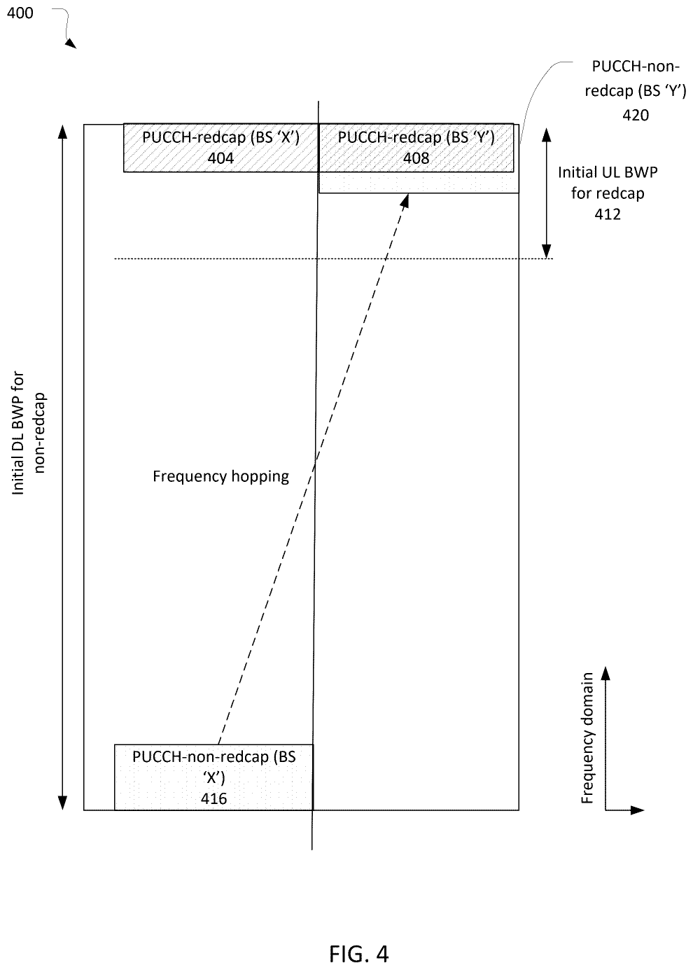

FIG. 4 illustrates a resource grid 400 having PUCCH regions for redcap and non-recap users in accordance with some embodiments. The resource grid 400 may be used to illustrate different approaches for configuration of resource blocks of PUCCH-non-redcap and PUCCH-redcap regions that are at least partially overlapped in a frequency domain.

The resource grid 400 may include PUCCH-redcap 404 and PUCCH-redcap 408 in an initial UL BWP for redcap 412. No frequency hopping may be performed with respect to the two PUCCH-redcap regions of the initial UL BWP for redcap 412.

PUCCH-non-redcap regions may be configured for frequency hopping. For example, a first PUCCH-non-redcap 416 may occur outside of the initial UL BWP for redcap 412 and a second PUCCH-non-redcap 420 may occur within the initial UL BWP for redcap 412 and may overlap with the PUCCH-redcap 408.

In general, for frequency hopping, a different base sequence ‘m’ may be used for each hop. For example, the PUCCH-non-redcap 416 may have a first frequency hopping index and may use a base sequence ‘X,’ while the PUCCH-non-redcap 420 may have a second frequency hopping index and may use a base sequence ‘Y.’ PUCCH regions that do not use frequency hopping employ the same base sequence. For example, if the PUCCH-redcap 404 uses a base sequence ‘X,’ it would also be used for PUCCH-redcap 408. However, using base sequence ‘X’ for PUCCH-redcap 408 and base sequence ‘Y’ for PUCCH-non-redcap 420 may result in a strong cross-correlation due to the overlapping of the two regions. Such a strong cross-correlation may degrade PUCCH detection at the base station 108 for both redcap and non-redcap users. Thus, the present embodiment uses different base sequences ‘m’ for different parts of the PUCCH-redcap regions even without frequency hopping being enabled. This may be considered as using a virtual frequency hopping with the PUCCH-redcap 404 using base sequence ‘X’ and the PUCCH-redcap 408 using base sequence ‘Y,’ albeit in the same frequency location. The symbol division of the PUCCH-redcap regions may be determined based on the overlapping PUCCH-non-redcap resource, which is provided by SIB information for non-redcap UE and acquired by redcap UEs. For example, the UE 104 may determine that it needs to use a base sequence other than ‘X’ for PUCCH-redcap 408 given the fact that it is overlapped with PUCCH-non-redcap 420.

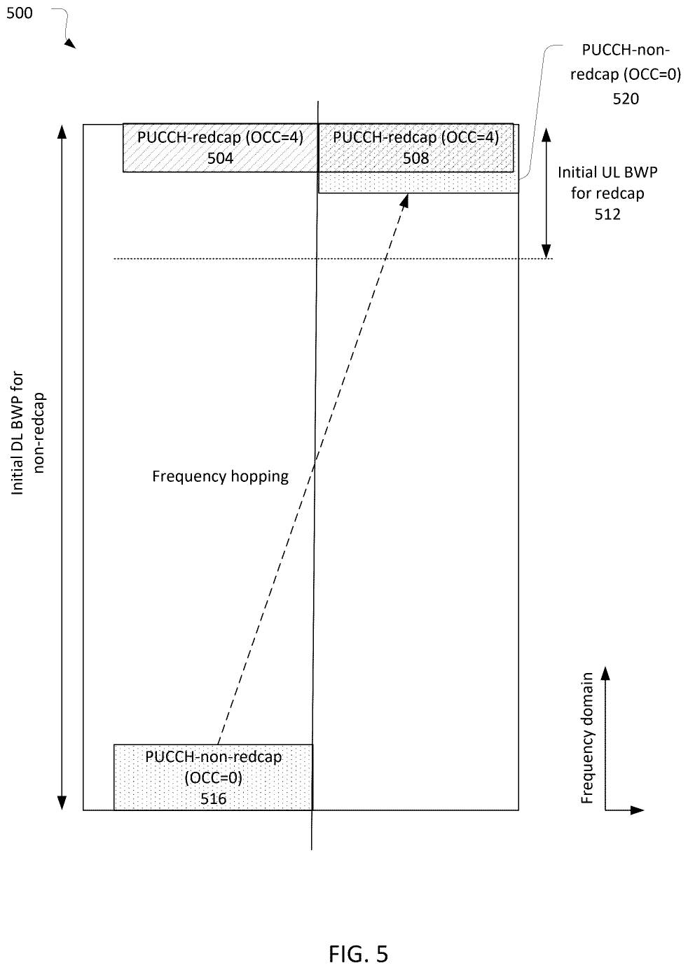

FIG. 5 illustrates a resource grid 500 having PUCCH regions for redcap and non-recap users in accordance with some embodiments. Similar to resource grid 400, the resource grid 500 may be used to illustrate different approaches for configuration of resource blocks of PUCCH-non-redcap and PUCCH-redcap regions that are at least partially overlapped in a frequency domain.

Similar to resource grid 400, resource grid 500 includes PUCCH-redcap 504 and PUCCH-redcap 508 within an initial UL BWP for redcap 512. No frequency hopping is enabled for transmissions in the PUCCH-redcap regions. The resource grid 500 further includes PUCCH-non-redcap 516 and PUCCH-non-redcap 520 to accommodate uplink transmissions with frequency hopping.

The present embodiment avoids the strong cross-correlation due to the PUCCH redcap 508 being at least partially overlapped with the PUCCH-non-redcap 520 using an orthogonal cover code (OCC). Using different OCCs may increase orthogonality between redcap users and non-redcap users. The non-redcap user may use a new OCC with index X that is predefined in a 3GPP TS or configured by SIB, where XT≠0. In some designs, X=└i/2┘, where i is a number of symbols of the PUCCH-redcap, which encompass both PUCCH-redcap 504 and PUCCH-redcap 508.

As shown in the resource grid 500, the uplink transmissions in PUCCH-non-redcap 516 and PUCCH-non-redcap 520 may use an OCC=0. This value may be predefined in a 3GPP TS. In order to provide the desired orthogonality, and assuming the PUCCH-redcap regions 504 and 508 encompass eight OFDM symbols, i=8, the redcap UE 104 may use an OCC=X=└i/2┘=└i/2┘=4.

With respect to the third aspect, various procedures are described for Msg1-based and Msg3-based early indications.

In a first option, the mechanism for providing early identification of redcap UEs may be explicitly configured in a SIB. For example, the base station 108 may use SIB information to enable Msg1-based early indication or Msg3-based early indication. This may be accomplished by using a two-bit IE in the SIB. The first bit may indicate whether Msg1-based early indication is enabled and the second bit may indicate whether Msg3-based early indication is enabled.

In a second option, only Msg3-based early identification for redcap UEs may be explicitly configured by the SIB information. The Msg1-based early identification of redcap UE may be implicitly configured if there is a separate RACH resource configured for redcap UEs. For example, if the SIB has a bit set to indicate that Msg3-based early identification is not enabled, the base station 108 may still enable Msg1-based early indication by specifically configuring a separate RACH resource for redcap UEs. Thus, when the base station 108 receives a Msg1 transmission in the redcap dedicated RACH resource, it will know the transmitting UE is a redcap UE.

In a third option, for a four-step RACH procedure, the redcap UEs may always indicate CCCH using the dedicated LCID in Msg3 PUSCH if it is claimed as a redcap UE, regardless of whether the RedCap UEs perform early indication in Msg1 or not.

In some embodiments, a redcap UE may not expect that both Msg1-based and Msg3-based early indication are enabled. Alternatively, both Msg1-based and Msg3-based early indication may be enabled and the redcap UE may select Msg1 or Msg3 for early indication based on capabilities of the UE. In this manner, the redcap UE may signal the UE capabilities to the base station. For example, Table 6 indicates redcap UE indications that may be used to signal UE capability when both Msg1-based and Msg3-based early indications are enabled.

TABLE 6

| Selected early indication | |
|---|---|
| resource | UE capability |
| Msg1-based | Redcap UE with 1-Rx and 1 MIMO layer |
| Msg3-based | Redcap UE with 2-Rx and 2 MIMO layers or |
| | HD-FDD UE |

For example, if the UE 104 utilizes Msg1 to indicate it is a redcap UE, the base station 108 may determine the UE 104 has one receive chain (Rx) and one multiple input multiple output (MIMO)-layer capabilities. If the UE 104 utilizes Msg 3 to indicate it is a redcap UE, the base station 108 may determine the UE 104 has two receive chains and two MIMO layer capabilities or it is a half-duplex (HD)-frequency division duplex (FDD) UE. In some embodiments, the UE 104 utilizing both Msg1 and Msg3 to indicate it is a RedCap UE may be associated with other UE capabilities. Various associations may be accommodated in this manner.

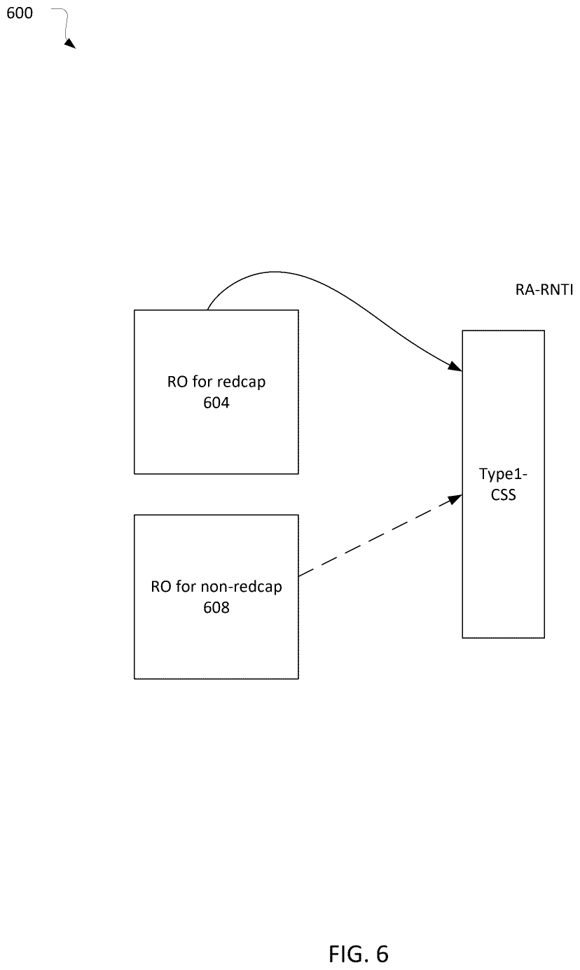

FIG. 6 illustrates a resource configuration 600 in accordance with some embodiments. The resource configuration 600 may include an RO for redcap 604 and an RO for non-redcap 608. If both of these ROs are associated with a common index in the frequency domain, there is potential for an overlapped PRACH resource. For example, an RA-RNTI value (RA-RNTI) may be generated based on Equation 2 as follow:

$$RA = RNTI = 1 + {s}_{ID} + 14 * {t}_{ID} + 14 * 80 * {f}_{ID} + 14 * 80 * 80 * {UL}_{carrier\_ID} , \qquad Equation 2$$

where f_{ID} is an index of the RO in a frequency domain, s_{ID} is the index of the first OFDM symbol of the PRACH occasion, t_{ID} is the index of the first slot of the PRACH occasion in a system frame, UL_{carrier_ID} is an index of the uplink carrier. In the event f_{ID} is the same for both the RO for redcap 604 and the RO for non-redcap 608, the calculated RA-RNTI may be the same. Therefore, there may be some ambiguity as to the desired recipient of a downlink transmission in Type1-CSS 612 that uses the RA-RNTI. In order to address this issue, the base station 108 may use one of the reserved bits in a DCI format 1_0 with CRC scrambled by RA-RNTI or MsgB-RNTI to indicate whether the RA-RNTI is associated with a PRACH resource reserved for redcap UEs (for example, RO 604) or a PRACH resource for non-redcap UEs (for example, RO 608). The PRACH resource may be used for the preamble transmission of a RACH procedure (for example, Msg1).

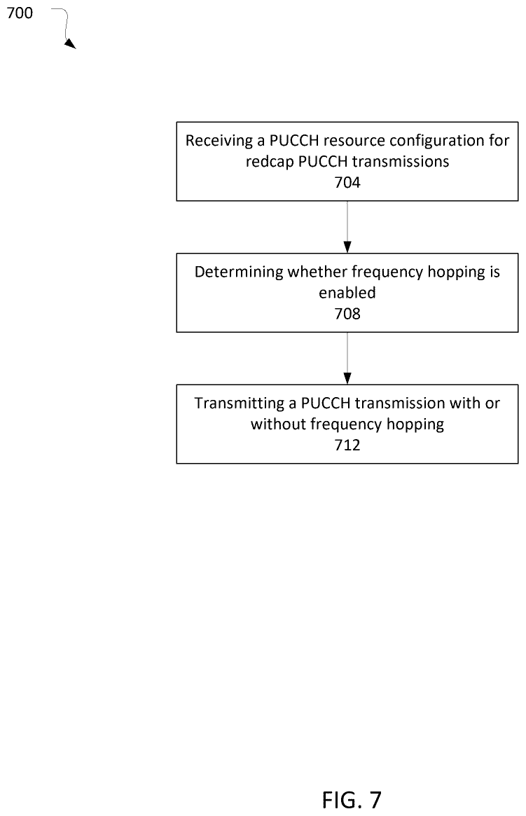

FIG. 7 may include an operation flow/algorithmic structure 700 in accordance with some embodiments. The operation flow/algorithmic structure 700 may be performed or implemented by a redcap UE such as, for example, UE 104 or 1000; or components thereof, for example, baseband processor 1004A

The operation flow/algorithmic structure 700 may include, at 704, receiving a PUCCH resource configuration for redcap PUCCH transmissions. The PUCCH resource configuration may be received while the UE is not in an RRC connected state. For example, the UE may be in an RRC idle state or an RRC inactive state. The PUCCH resource configuration may be received in a SIB, for example, a SIB1 or a SIB-redcap.

The operation flow/algorithmic structure 700 may further include, at 708, determining whether frequency hopping is enabled. The determination may be based on an indication within the PUCCH resource configuration. In some embodiments, the indication of whether frequency hopping is enabled may be within one or more bits of a DAI field of a DCI format 1_0 transmission. The indication may include a plurality of bits, which may allow the indication to provide more detail of the enabled frequency hopping. For example, a two-bit indication may indicate whether inter-slot hopping or intra-slot hopping is enabled.

In some embodiments, the indication may be based on a scrambling sequence used to scramble CRC bits of a DCI format 1_0 transmission.

The operation flow/algorithmic structure 700 may further include, at 712, transmitting a PUCCH transmission with or without frequency hopping.

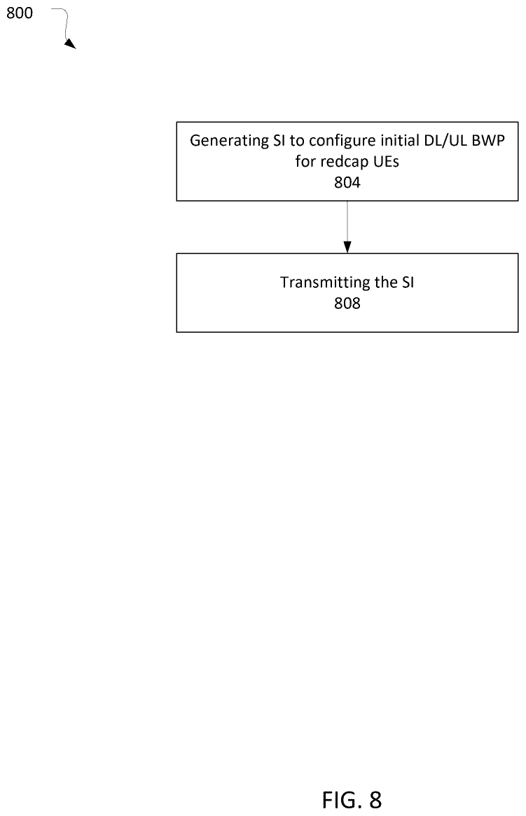

FIG. 8 may include an operation flow/algorithmic structure 800 in accordance with some embodiments. In some embodiments, the operation flow/algorithmic structure 800 may be performed or implemented by a base station, for example, base station 108 or 1100; or components thereof, for example, baseband processor 1104A.

The operation flow/algorithmic structure 800 may include, at 804, generating system information to configure initial DL/UL BWP for redcap UEs.

In some embodiments, the initial DL/UL BWP may be an initial DL BWP. The system information may include configuration information to configure the initial DL BWP with a frequency location and bandwidth, one or more CSS sets (for example, Type 0, Type 1, Type 2, or Type 3 CSS sets), or a non-CD-SSB location.

In some embodiments, the initial DL/UL BWP may be an initial UL BWP. The system information may include configuration information to configure redcap-dedicated parameters for UL transmission during RACH procedures. These parameters may include a RACH resource configuration with RACH parameters such as number of FDMed ROs, a power ramping step, a time-domain periodicity and density, and a number of SSBs associated with a valid RO. The system information may also include PUCCH resource configuration information to enable/disable frequency hopping or an RB offset to avoid collision with a PUCCH resource reserved for non-redcap UEs. The RB offset may indicate an offset of PUCCH-redcap resources with respect to a lowest PRB of an initial UL BWP for redcap.

The operation flow/algorithmic structure 800 may further include, at 808, transmitting the system information. The system information may be transmitted in a broadcast message. The broadcast message may be a SIB1 transmission or a SIB-redcap transmission.

In some embodiments, the operation flow/algorithmic structure 800 may also include transmitting an indication of whether BCCH (carried by the system information) has been modified for a redcap-specific configuration. This may be done by transmitting a DCI format 1_0 transmission with an indication of a BCCH modification as a bit within a short message field or another field in the DCI. Additionally/alternatively, the indication of BCCH modification may be based on a P-RNTI or scrambling sequence used to scramble CRC bits of the DCI format 1_0 transmission. Still further, the indication of BCCH modification may be based on a search space in which the DCI format 1_0 is transmitted.

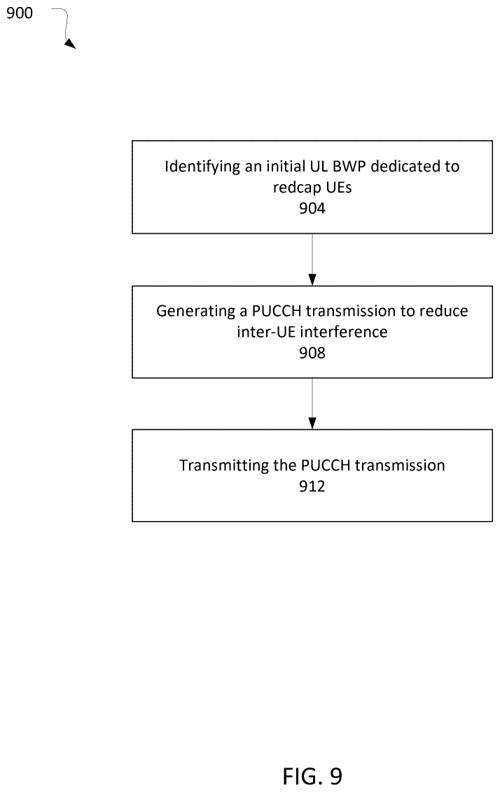

FIG. 9 may include an operation flow/algorithmic structure 900 in accordance with some embodiments. The operation flow/algorithmic structure 900 may be performed or implemented by a UE such as, for example, UE 104 or 1000; or components thereof, for example, baseband processor 1004A

The operation flow/algorithmic structure 900 may include, at 904, identifying an initial UL BWP dedicated to redcap UEs.

It is noted that dedication of the initial UL BWP to the redcap UEs implies that the set of configuration parameters that define the BWP are to be used by redcap UEs. Other UEs, including non-redcap UEs, may be configured with other BWPs that may have resources (for example, time or frequency resources) that overlap with the initial UL BWP dedicated to redcap UEs. For example, with reference to FIG. 3, a BWP configured for non-redcap UEs may be an entire bandwidth of up to 100 MHz, while two initial UL BWPs 320 and 324 are configured for redcap UEs with resource block sets that are subsets of the larger resource block set.

The operation flow/algorithmic structure 900 may further include, at 908, generating a redcap PUCCH transmission to reduce inter-UE interference with a non-redcap PUCCH transmission that is at least partially within the initial uplink BWP.

In some embodiments, the redcap PUCCH transmission may be generated by selecting a set of resource blocks that are adjacent to the set of resource blocks used for the non-redcap PUCCH transmission. Thus, even though the non-redcap PUCCH transmission may be at least partially in the initial UL BWP for redcap, the actual PUCCH transmissions will not overlap in the frequency domain.

In other embodiments, the redcap PUCCH transmission may at least partially overlap in the frequency domain with the non-redcap PUCCH transmission. In these embodiments, the redcap PUCCH transmission may be generated to avoid inter-UE interference by selection of base sequences or OCCs to be used for the redcap PUCCH transmission.

For example, in some embodiments, the redcap PUCCH transmission may be separated into first and second portions. The second portion may be overlapped with the non-redcap PUCCH transmission in both the time domain and the frequency domain. The first portion of the redcap PUCCH transmission may be generated with a first base sequence, and the second portion of the redcap PUCCH transmission may be generated with a second base sequence. This may be the case even though there is no frequency hopping between the first and second portions of the redcap PUCCH transmission.

In other example, the redcap PUCCH transmission may be generated using a non-zero index for OCC. The index value of the OCC used may be based on the number of OFDM symbols used for the redcap PUCCH transmission. This may provide some orthogonality with respect to the non-redcap PUCCH transmission, which will use a zero index for OCC.

The operation flow/algorithmic structure 900 may further include, at 912, transmitting the PUCCH transmission.

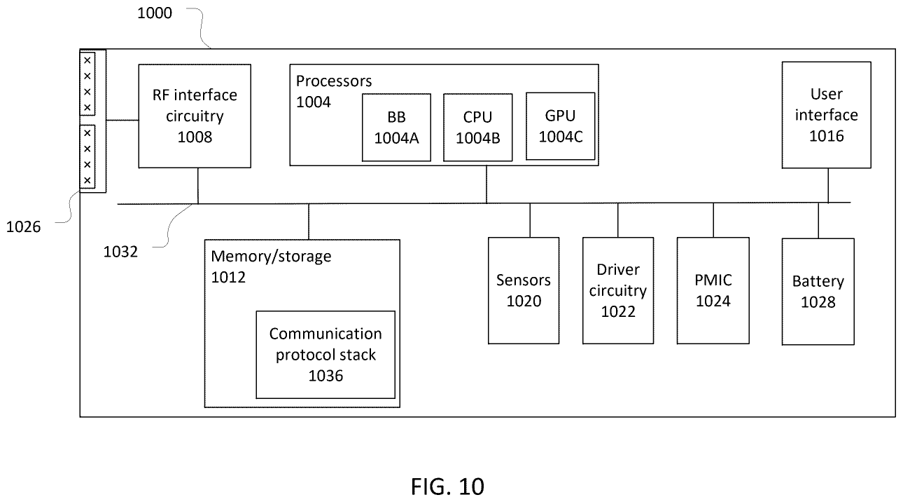

FIG. 10 illustrates a UE 1000 in accordance with some embodiments. The UE 1000 may be similar to and substantially interchangeable with redcap UE 104.

The UE 1000 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1000 may include processors 1004, RF interface circuitry 1008, memory/storage 1012, user interface 1016, sensors 1020, driver circuitry 1022, power management integrated circuit (PMIC) 1024, antenna structure 1026, and battery 1028. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1032, which may represent any type of interface, input/output, bus (local, system, or expansion), transmission line, trace, or optical connection that allows various circuit components (on common or different chips or chipsets) to interact with one another.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack 1036 to: perform user plane functions at a PHY layer, MAC layer, RLC layer, PDCP layer, and SDAP layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1012 may include one or more non-transitory, computer-readable media that includes instructions (for example, communication protocol stack 1036) that may be executed by one or more of the processors 1004 to cause the UE 1000 to perform various operations described herein. The memory/storage 1012 include any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR and sidelink access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands including bands in FR1 or FR2.

The user interface circuitry 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensor circuitry 1020 and control and allow access to sensor circuitry 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

A battery 1028 may power the UE 1000, although in some examples the UE 1000 may be mounted deployed in a fixed location, and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

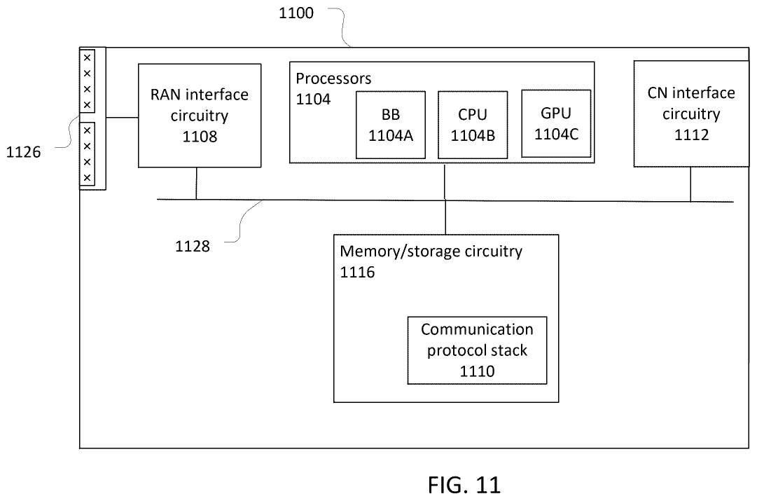

FIG. 11 illustrates a base station 1100 in accordance with some embodiments. The base station 1100 may be similar to and substantially interchangeable with base station 108 of FIG. 1.

The base station 1100 may include processors 1104, RF interface circuitry 1108 (if implemented as a base station), core network (CN) interface circuitry 1112, memory/storage circuitry 1116, and antenna structure 1126 (if implemented as a base station).

The components of the base station 1100 may be coupled with various other components over one or more interconnects 1128.

The processors 1104, RF interface circuitry 1108, memory/storage circuitry 1116 (including communication protocol stack 1110), antenna structure 1126, and interconnects 1128 may be similar to like-named elements shown and described with respect to FIG. 10.

The CN interface circuitry 1112 may provide connectivity to a core network, for example, a 5th Generation Core network (5GC) using a 5GC-compatible network interface protocol such as carrier Ethernet protocols, or some other suitable protocol. Network connectivity may be provided to/from the base station 1100 via a fiber optic or wireless backhaul. The CN interface circuitry 1112 may include one or more dedicated processors or FPGAs to communicate using one or more of the aforementioned protocols. In some implementations, the CN interface circuitry 1112 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method of operating a base station, the method comprising: generating system information to configure an initial downlink (DL)/uplink (UL) bandwidth part (BWP) dedicated to reduced-capability (redcap) user equipments (UEs); and transmitting the system information in a broadcast message.

Example 2 includes the method of example 1 or some other example herein, wherein the broadcast message comprises a system information block 1 (SIB1) or a system information bock-redcap (SIB-redcap).

Example 3 includes method of example 1 or some other example herein, wherein the initial DL/UL BWP comprises an initial DL BWP and the system information includes an indication of a frequency location and bandwidth of the initial DL/UL BWP.

Example 4 includes a method of example 1 or some other example herein, wherein the initial DL/UL BWP comprises an initial DL BWP and the system information includes an indication of a common search space for a random access message, a system information block (SIB), or a paging message.

Example 5 includes the method of example 1 or some other example herein, wherein the initial DL/UL BWP comprises an initial DL BWP and the system information includes an indication of a location of a non-cell-defined synchronization signal block.

Example 6 includes the method of example 5 or some other example herein, wherein the indication comprises an absolute radio-frequency channel number.

Example 7 includes the method of example 1 or some other example herein, wherein the initial DL/UL BWP comprises an initial UL BWP and the system information comprises redcap-dedicated parameters for uplink transmission during a random access channel (RACH) procedure.

Example 8 includes the method of example 7 or some other example herein, wherein the redcap-dedicated parameters comprise a number of frequency-domain multiplexed RACH occasions, a power-ramping step, a time-domain periodicity, a time-domain density, or a number of synchronization signal blocks associated with a valid RACH occasion.

Example 9 includes the method of example 1 or some other example herein, wherein the initial DL/UL BWP comprises an initial UL BWP and the system information comprises redcap-dedicated parameters for physical uplink control channel (PUCCH) transmissions, the redcap-dedicated parameters to include a resource block offset for PUCCH-redcap resources with respect to a lowest physical resource block (PRB) of the initial UL BWP.

Example 10 includes the method of example 1 or some other example herein, wherein the initial DL/UL BWP comprises an initial UL BWP and the system information comprises an indication of whether frequency hopping is enabled or disabled for a physical uplink control channel transmission.

Example 11 includes a method of any one of examples 1-10 or some other example herein, further comprising: generating and transmitting downlink control information (DCI) to indicate a broadcast control channel (BCCH) modification for redcap-specific configuration.

Example 12 includes the method of example 11 or some other example herein, wherein the DCI comprises DCI format 1_0 having an indication of the BCCH modification as a bit within a first field that is a short message field or a second field.

Example 13 includes the method of example 12 or some other example herein, wherein the bit within the first field corresponds to a reserved bit in a short message field in a new radio (NR) Release 15 or Release 16.

Example 14 includes the method of example 11 or some other example herein, wherein the DCI comprises DCI format 1_0 and the method further comprises: using a paging radio network temporary identifier (P-RNTI) or scrambling sequence to scramble cyclic redundancy check (CRC) bits of the DCI format 10 to provide an indication of the BCCH modification.

Example 15 includes a method of example 11 or some other example herein, further comprising: transmitting the DCI within a common search space configured for redcap UEs to provide an indication of the BCCH modification.

Example 16 includes a method of operating a reduced capability (redcap) user equipment (UE), the method comprising: receiving, from a base station, a physical uplink control channel (PUCCH) resource configuration for redcap PUCCH transmissions; determining, based on the PUCCH resource configuration, whether frequency hopping is enabled; and transmitting a PUCCH transmission with or without frequency hopping based on said determining of whether frequency hopping is enabled.

Example 17 includes the method of example 16 or some other example herein, wherein the PUCCH resource configuration includes an indication of whether frequency hopping is enabled and the method further comprises: receiving the indication in a system information block 1 (SIB1) or a system information block-redcap (SIB-redcap).

Example 18 includes a method of example 16 or some other example herein, wherein the PUCCH resource configuration includes an indication of whether frequency hopping is enabled and the method further comprises: receiving the indication in a downlink assignment index (DAI) field of a downlink control information (DCI) format 1_0 transmission.

Example 19 includes a method of example 18 or some other example herein, wherein the indication is a two-bit indication that indicates whether intra-slot hopping or inter-slot hopping is enabled.

Example 20 includes the method of example 16 or some other example herein, further comprising: determining a scrambling sequence used to scramble cyclic redundancy check (CRC) bits of a downlink control information (DCI) format 1_0 transmission; and determining the PUCCH resource configuration based on the scrambling sequence.

Example 21 includes a method of operating a reduced capability (redcap) user equipment (UE), the method comprising: identifying an initial uplink bandwidth part (BWP) dedicated to redcap user UEs; generating a first physical uplink control channel (PUCCH) transmission to reduce inter-UE interference with a second PUCCH transmission from a non-redcap UE that is at least partially within the initial uplink BWP; and transmitting the first PUCCH transmission.

Example 22 includes a method of example 21 or some other example herein, further comprising: identifying, for the first PUCCH transmission, a set of resource blocks adjacent to resource blocks configured for the second PUCCH transmission from the non-redcap UE.

Example 23 includes method of example 21 or some other example herein, wherein a set of resource blocks configured for the second PUCCH transmission from the non-redcap UE at least partially overlap with a set of resource blocks configured for the first PUCCH transmission for the redcap UE.

Example 24 includes the method of example 23 or some other example herein, wherein generating the PUCCH transmission comprises: identifying a first portion of the PUCCH transmission and a second portion of the PUCCH transmission, wherein the second portion of the PUCCH transmission is to be transmitted in a PUCCH resource that at least partially overlaps in a time-domain and a frequency domain with a PUCCH resource of a non-redcap UE; generating the first portion of the PUCCH transmission using a first base sequence; and generating the second portion of the PUCCH transmission using a second base sequence.

Example 25 includes a method of example 23 or some other example herein, wherein generating the PUCCH transmission comprises: determining a non-zero value for an orthogonal cover code (OCC); and generating the PUCCH transmission using the OCC with the non-zero value.

Example 26 includes a method of example 25 or some other example herein, wherein the non-zero value is predefined or configured by a base station.

Example 27 includes the method of example 25 or some other example herein, further comprising: determining a number of orthogonal frequency division multiplexing (OFDM) symbols; and determining the non-zero value for the OCC based on the number of OFDM symbols.

Example 28 includes a method of example 27 or some other example herein, wherein the non-zero value is X, the number of OFDM symbols is i, and X=└i/2┘.

Example 29 includes a method of operating a user equipment (UE), the method comprising: determining whether early reduced capability (redcap) indication is enabled for message 1 (Msg1) or message 3 (Msg3) of a random access channel (RACH) procedure; generating, based on said determining, a RACH message to include an identification that the UE is a redcap UE; and transmitting the RACH message.

Example 30 includes the method of example 29 or some other example herein, further comprising: determining early redcap indication is enabled for both Msg1 and Msg3; and selecting Msg1 or Msg3 for the RACH message based on a capability of the UE.

Example 31 includes a method of example 29 or some other example herein, further comprising: receiving downlink control information (DCI) with cyclic redundancy check (CRC) bits scrambled by random access-radio network temporary identity (RA-RNTI); detecting a value in a field of the DCI; and determining whether the RA-RNTI is associated with a physical random access channel (PRACH) resource reserved for redcap UEs based on the detected value.

Example 32 includes the method of example 30 or some other example herein, wherein the field of the DCI corresponds to a reserved bits field. Example 33 may include an apparatus comprising means to perform one or more elements of a method described in or related to any of examples 1-32, or any other method or process described herein.

Example 34 may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Example 35 may include an apparatus comprising logic, modules, or circuitry to perform one or more elements of a method described in or related to any of examples 1-32, or any other method or process described herein.

Example 36 may include a method, technique, or process as described in or related to any of examples 1-32, or portions or parts thereof.

Example 37 may include an apparatus comprising: one or more processors and one or more computer-readable media comprising instructions that, when executed by the one or more processors, cause the one or more processors to perform the method, techniques, or process as described in or related to any of examples 1-32, or portions thereof.

Example 38 may include a signal as described in or related to any of examples 1-32, or portions or parts thereof.

Example 39 may include a datagram, information element, packet, frame, segment, PDU, or message as described in or related to any of examples 1-32, or portions or parts thereof, or otherwise described in the present disclosure.

Example 40 may include a signal encoded with data as described in or related to any of examples 1-32, or portions or parts thereof, or otherwise described in the present disclosure.

Example 41 may include a signal encoded with a datagram, IE, packet, frame, segment, PDU, or message as described in or related to any of examples 1-32, or portions or parts thereof, or otherwise described in the present disclosure.

Example 42 may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Example 43 may include a computer program comprising instructions, wherein execution of the program by a processing element is to cause the processing element to carry out the method, techniques, or process as described in or related to any of examples 1-32, or portions thereof.

Example 44 may include a signal in a wireless network as shown and described herein.

Example 45 may include a method of communicating in a wireless network as shown and described herein.

Example 46 may include a system for providing wireless communication as shown and described herein.

Example 47 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processor circuitry to:
receive, from a base station, a physical uplink control channel (PUCCH) resource configuration;
determine, based on the PUCCH resource configuration, whether frequency hopping is enabled for reduced capacity (RedCap) user equipments (UEs); and
generate a PUCCH transmission with or without frequency hopping based on determination whether frequency hopping is enabled for RedCap UEs.

2. The one or more non-transitory, computer-readable media of claim 1, wherein the processor circuitry is to receive the PUCCH resource configuration as part of an initial uplink bandwidth part (BWP) for RedCap configuration.

3. The one or more non-transitory, computer-readable media of claim 2, wherein the PUCCH resource configuration includes an indication of whether frequency hopping is enabled.

4. The one or more non-transitory, computer-readable media of claim 3, wherein the initial uplink BWP for RedCap configuration is to configure an initial uplink BWP for RedCap UEs and the indication is to indicate whether intra-slot frequency hopping is enabled within the initial uplink BWP for RedCap UEs.

5. The one or more non-transitory, computer-readable media of claim 2, wherein the instructions, when executed, further cause the processor circuitry to:
identify the initial uplink BWP for RedCap configuration based on system information block 1 (SIB1) or a system information block-redcap (SIB-redcap).

6. The one or more non-transitory, computer-readable media of claim 1, wherein the instructions, when executed, further cause the processor circuitry to:
receive system information that provides RedCap-dedicated parameters for uplink transmissions.

7. The one or more non-transitory, computer-readable media of claim 6, wherein the RedCap-dedicated parameters are for uplink transmissions during a random access channel (RACH) procedure.

8. A method comprising:
receiving, from a base station, a physical uplink control channel (PUCCH) resource configuration;
determining, based on the PUCCH resource configuration, whether frequency hopping is enabled for reduced capacity (RedCap) user equipments (UEs); and
generating a PUCCH transmission with or without frequency hopping based on determination whether frequency hopping is enabled for RedCap UEs.

9. The method of claim 8, further comprising:
receiving the PUCCH resource configuration as part of an initial uplink bandwidth part (BWP) for RedCap configuration.

10. The method of claim 9, wherein the PUCCH resource configuration includes an indication of whether frequency hopping is enabled.

11. The method of claim 10, wherein the initial uplink BWP for RedCap configuration is to configure an initial uplink BWP for RedCap UEs and the indication is to indicate whether intra-slot frequency hopping is enabled within the initial uplink BWP for RedCap UEs.

12. The method of claim 9, further comprising:
identifying the initial uplink BWP for RedCap configuration based on system information block 1 (SIB1) or a system information block-redcap (SIB-redcap).

13. The method of claim 8, further comprising:
receiving system information that provides RedCap-dedicated parameters for uplink transmissions.

14. The method of claim 13, wherein the RedCap-dedicated parameters are for uplink transmissions during a random access channel (RACH) procedure.

15. A method comprising:
generating, for transmission to a user equipment (UE), a physical uplink control channel (PUCCH) resource configuration that includes an indication of whether frequency hopping is enabled for reduced capacity (RedCap) UEs; and
receiving a PUCCH transmission with or without frequency hopping from the UE.

16. The method of claim 15, further comprising:
generating the PUCCH resource configuration as part of an initial uplink bandwidth part (BWP) for RedCap configuration.

17. The method of claim 16, wherein the initial uplink BWP for RedCap configuration is to configure an initial uplink BWP for RedCap UEs and the indication is to indicate whether intra-slot frequency hopping is enabled within the initial uplink BWP for RedCap UEs.

18. The method of claim 16, further comprising:
generating system information block 1 (SIB1) or a system information block-redcap (SIB-redcap) to identify the initial uplink BWP for RedCap configuration.

19. The method of claim 15, further comprising:
generating system information that provides RedCap-dedicated parameters for uplink transmissions.

20. The method of claim 19, wherein the RedCap-dedicated parameters are for uplink transmissions during a random access channel (RACH) procedure.
